(19) United States
(12) Patent Application Publication
(10) Pub. No.: US 2008/0046392 A1
(43) Pub. Date: Feb. 21, 2008

(54) SYSTEM AND METHODS FOR DETERMINING THE DECISION-MAKING COMPETENCE OF A SUBJECT

(76) Inventors: Gordon Leslie Clark, Oxford (GB); Emiko Claire Caerlewy-Smith, Brighton (GB); John C. Marshall, Oxford (GB)

Correspondence Address: STITES & HARBISON PLLC, 401 COMMERCE STREET, SUITE 800, NASHVILLE, TN, 37219, US

(21) Appl. No.: 11/466,037

(22) Filed: Aug. 21, 2006

(51) Int. Cl. G06F 17/00

(52) U.S. Cl. 706/46

(57) ABSTRACT

A method for determining the individual and collective decision-making competence, consistency, knowledge and understanding, and governance structures of an individual ro collective body in the field of investment/financial management, or similar position of responsibility, wherein questionnaires are filled out by the subject(s) which are designed to ascertain their opinions, attitudes and/or beliefs within their field, and evaluate their decision-making styles and problem-solving processes. The answers are coded, input, analysed and used to evaluate the competence and consistency of the subjects' individual and collective decision-making.

### FIELD OF THE INVENTION

This invention relates generally to a system and method, and a database of questions for use in such a system and method, for determining individual and collective decision-making competence, consistency, knowledge and understanding, and the efficacy of governance structures. This is specifically but not necessarily exclusively within the field of pension fund investment.

### SUMMARY OF THE INVENTION

One aspect of the present invention include a method of determining one or more of the decision-making competence, consistency, knowledge and understanding and governance structures of subject(s) in a specified field of risk, the method comprising obtaining answers to a first set of questions designed to ascertain opinions, attitudes and/or beliefs of said subject(s) within said specified field, obtaining answers to a second set of questions designed to evaluate decision-making styles and/or problem-solving processes of said subject(s), and correlating said answers to said first and second sets of questions so as to determine the individual and/or collective decision-making competence of said subject(s) within said field.

In embodiments of the invention, the first set of questions can comprise a continuation of questions designed to determine one or more of demographic background relating to said subject(s), attitude of raid subject to governance of said specified field, and knowledge and understanding of said subject(s) in respect of key aspects of said specified field. In other embodiments, the the said second set of questions can comprise a combination of questions designed to test key problem-solving and/or decision-making skills of said subject(s) in respect of their duties with said specified field.

Another aspect of the present invention is a questionnaires (tools) for use in the methods described herein. Yet another aspect of the present invention is a database in which is stored a plurality of questions for use in the methods described herein. They may include, for example, questions including at least a set of questions designed to ascertain opinions, attitudes and/or beliefs of said subject(s) within said specified field and a second questionnaire comprising a set of questions designed to evaluate decision-making styles and/or problem-solving processes of said subject(s).

Another aspect of the preset invention is a system for determining one or more of the individual and/or collective decision-making competence, consistency, knowledge and understanding, and governance structures of subject(s) in a specified field of risk, the system comprising an input for receiving a subject's answers to the sets of questions provided in the first and second respective questionnaires as defined above, an analysis tool for correlating data representative of said answers and generating visual and/or graphic representations of said answers, and a display for displaying said representations so as to enable a user to determine therefrom one or more of the decision-making competence, consistency, knowledge and understanding, and governance structures of said subject(s) within said field.

### BRIEF DESCRIPTION OF THE DRAWINGS

FIG. 1 is a graph that represents a histogram that shows responses to questions A(41) and B(1) of Example 3.

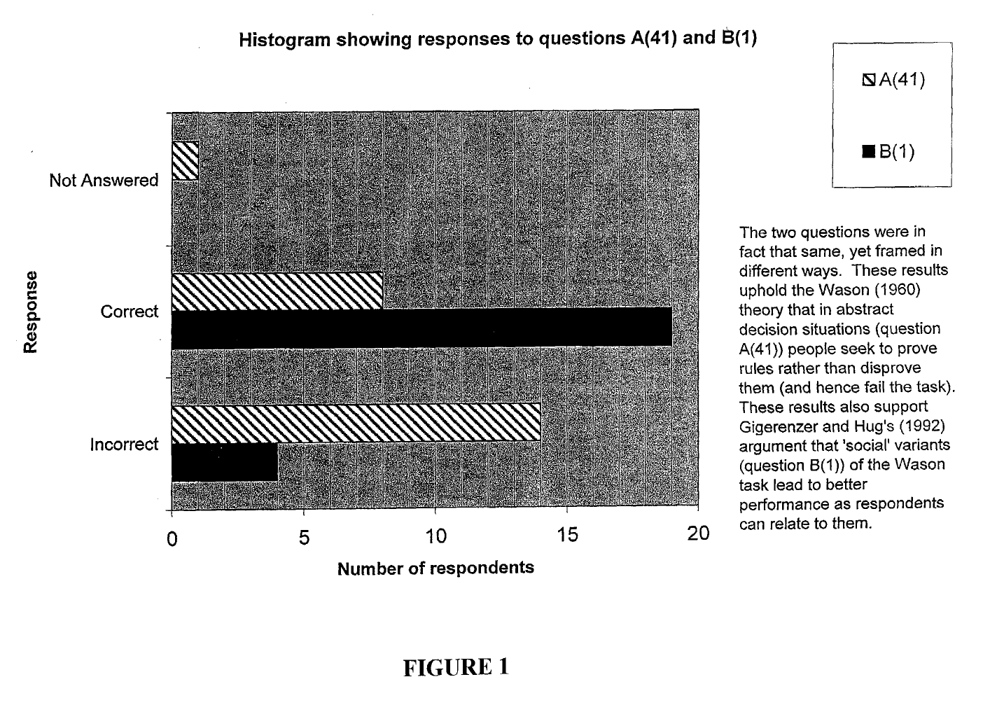

FIG. 2 is a graph showing responses to question B(2) of Example 3.

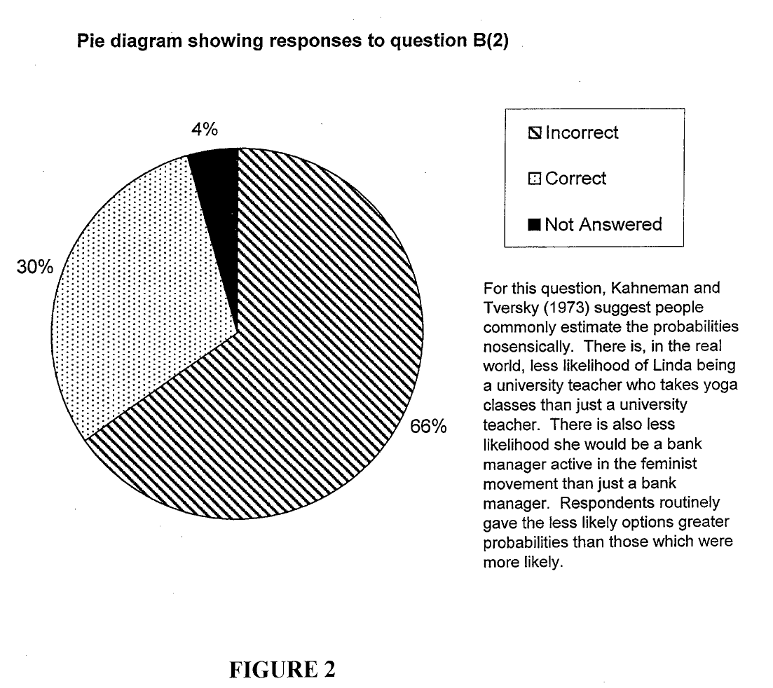

FIG. 3 is a graph of boxplots showing dispersion of responses for question B(15) of Example 3.

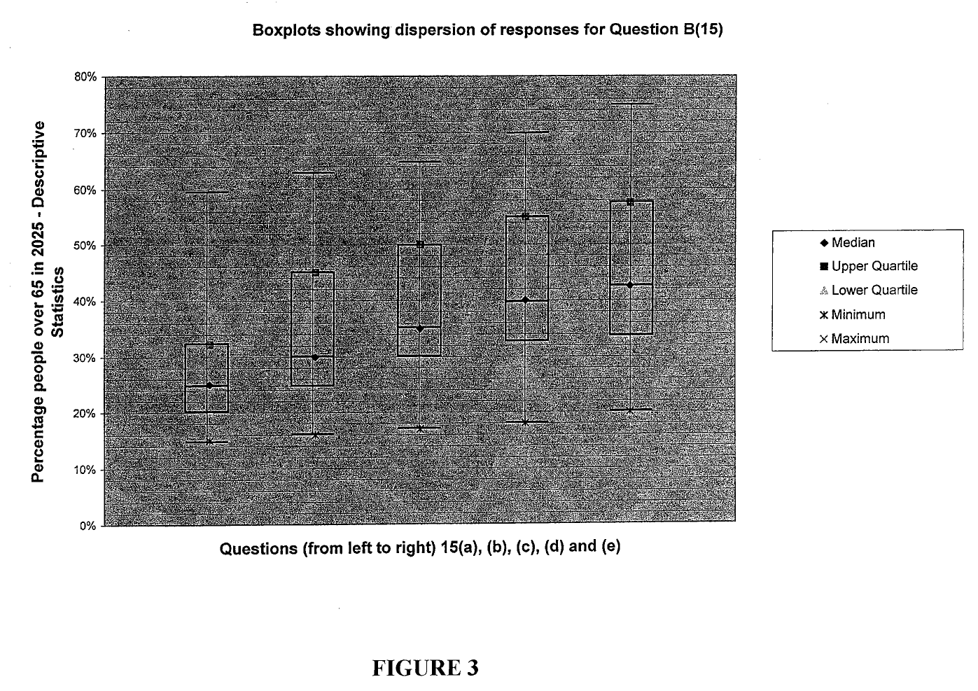

FIG. 4 is a graph that represents a histogram that shows responses to question B(30) of Example 3.

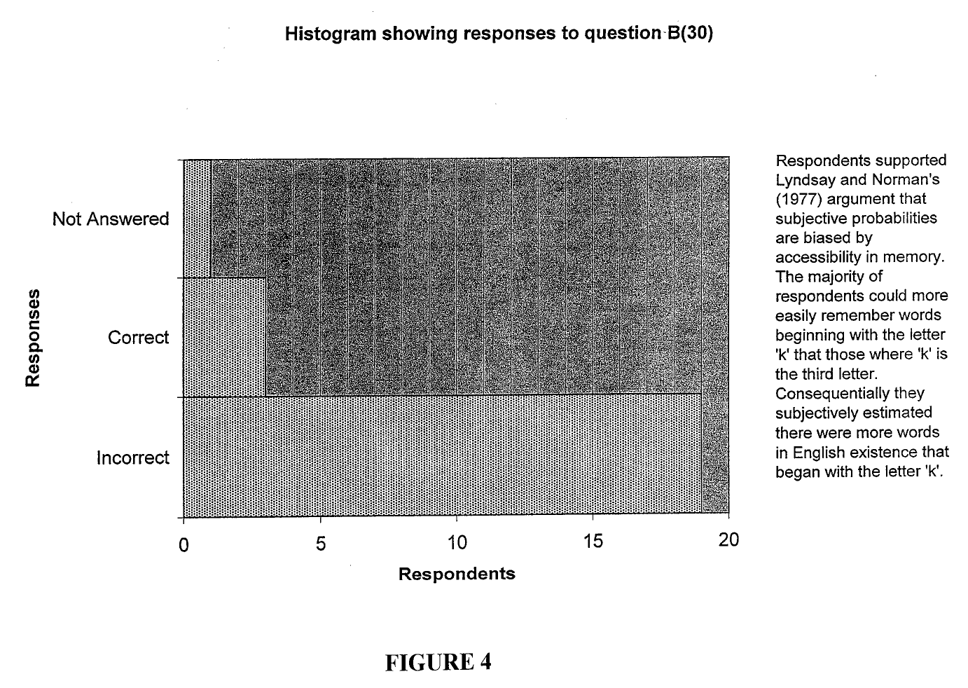

FIG. 5 is a graph that represents a histogram that shows responses to question B(31) of Example 3.

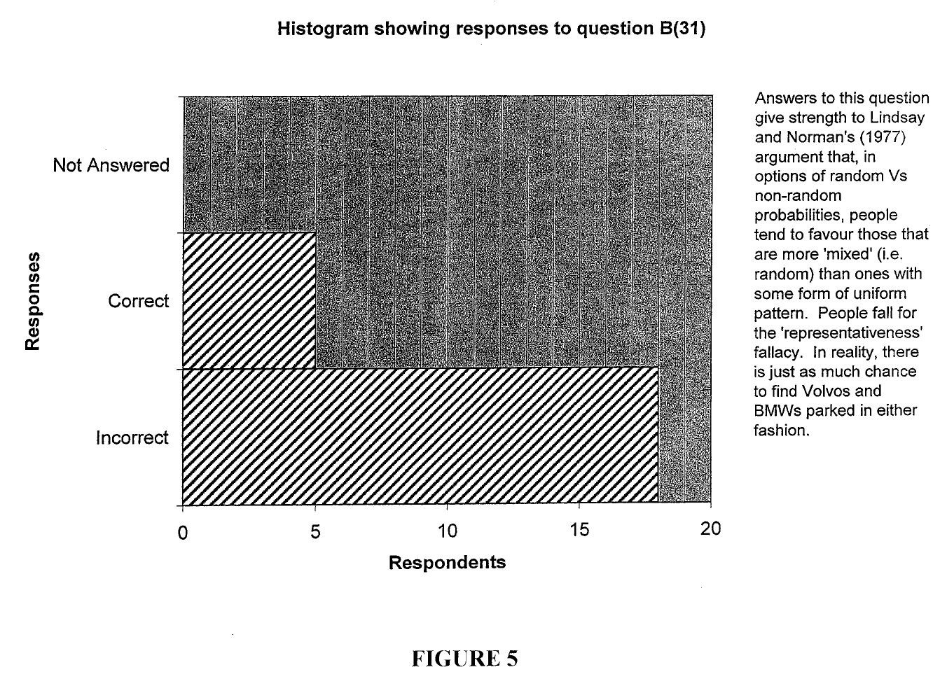

### DESCRIPTION OF THE INVENTION

In order to generate a long-term retirement income, most people in the developed world plan and maintain savings programs to meet their income aspirations. The success of these savings programs depends a great deal on the competence and consistency of individual and collective decision-making. It is therefore highly desirable to determine the levels of consistency and competence of such decision-making, with a long-term view to improving individual and collective competency in order to safeguard the nominal retirement welfare of millions of people.

In accordance with the present invention, there is provided a method of determining the decision-making competence of a subject/subjects in a specified field of making decisions under risk and uncertainty: the method comprising obtaining answers to a first set of questions designed to ascertain opinions, attitudes and/or beliefs of said subject(s) within said specified field, obtaining answers to a second set of questions designed to evaluate decision-making styles and problem-solving processes of said subject, and correlating said answers to said first and second sets of questions so as to determine the decision-making competence, consistency, knowledge and understanding, and governance structures of said subject(s) within said field.

Also in accordance with the present invention, there is provided questionnaires (tools) for use in the method defined above, said questionnaires including a first questionnaire, which comprises a set of questions designed to ascertain opinions, attitudes and/or beliefs of said subject(s) within said specified field and a second questionnaire comprising a set of questions designed to evaluate decision-making styles and problem-solving processes of said subject(s).

Also in accordance with the present invention, there is provided a database in which is stored a plurality of questions for use in a method as defined above, the questions including at least a set of questions designed to ascertain opinions, attitudes and/or beliefs of said subject(s) within said specified field and a second questionnaire comprising a set of questions designed to evaluate decision-making styles and problem-solving processes of said subject(s).

Still further in accordance with the present invention, there is provided a system for determining the decision-making competence of a subject/subjects in a specified field of risk, the system comprising: an input for receiving a subjects' answers to the sets of questions provided in the first and second respective questionnaires as defined above; a coding system to classify and store such answers; an analysis methodology for correlating data representative of said answers and generating visual and/or graphical representations of said answers; and a presentation format for displaying said representations so as to enable a user to determine therefrom the decision-making competence, consistency, knowledge and understanding and governance structures of said subject(s) within said field, both individually and collectively.

Thus in a preferred exemplary embodiment of the invention, methodologies from the fields of psychology, economics, sociology and other social sciences are used to provide a set of questions, puzzles and tests are combined to create a coherent questionnaire-based assessment tool. Furthermore, the combination of methods and analysis of results provides original in-depth assessment of individual and collective decision-making skills, key competencies, consistency, governance and effectiveness.

Beneficially, said first set of questions comprises a continuation of questions designed to determine one or more of demographic background relating to said subject(s), attitude of said subject(s) to governance of said specified field, and knowledge and understanding of said subject(s) in respect of key aspects of said specified field.

Beneficially, said second set of questions comprises a combination of questions designed to test key problem-solving and/or decision-making skills of said subject(s) with relevance to their duties with said specified field. Such skills may include information efficiency, awareness of common decision-fallacies, knowledge and understanding of basic principles of probability, and knowledge demographics relating to said specified field.

In one exemplary embodiment, wherein data representative of said answer to said questions is coded and entered into a statistical analysis application, arranged and configured to correlate said answers and generate a visual representative of said correlated answers for use in analysis thereof.

These and other aspects of the present invention will be apparent from, and elucidated with reference to, the embodiments described herein.

Embodiments of the present invention will now be described by way of examples. The following Examples A, B, and C only show embodiments of the preset invention and should not be construed as being limiting thereof. A system according to an exemplary embodiment of the present invention comprises a questionnaire-based assessment tool for investigating the competence, consistency, knowledge and understanding, and governance of individual and collective decision-making, specifically within investment settings. However, it will be appreciated by a person skilled in the art that the system could be relatively easily tailored to assess individual and collective decision-making within other settings, such as on charitable trusts, corporate boards of directors, only for individual investors, etc. In fact, the basic principle of the proposed methodology could be applied to any individual or collective decision-maker in a position of responsibility.

The system receives as its inputs, a subjects' answers to a two questionnaires. The first questionnaire comprises a combination of questions designed to determine the demographic background, attitude to industry related governance, and “knowledge and understanding” of the subject(s).

Sample questions from a suitable first questionnaire are shown in Example A, below:

It can be seen in Example A that the questions asked determine the demographic background of the subject(s) are fairly straightforward, fact-based questions relating to age, sex, ethnicity, position, length of service and earnings.

Attitudes to governance may be tested from a number of different aspects, including:

The subject(s) may be asked what levels of risk they would accept when investing their own money and that of their members. These types of question enable the subjects' attitude to risk to be assessed, and allow a comparison between accepted risk levels taken with their own and other peoples' money, thereby analysing whether a subjects' personal risk profile influences the levels of risk they are prepared to tolerate when acting in their official capacity.

The subject(s) may be asked value-based questions that enable analysis of their confidence in external advice and their fellow board members.

The subject(s) may be asked their judgement-based questions on their opinion regarding board representativeness.

The subject(s) may be asked questions that test their knowledge regarding a collective's implementation of good governance principles (drawn from international best practice).

The subjects' knowledge and understanding can be tested by means of questions enabling them to self-evaluate their conversance, knowledge and understanding in respect of key aspects of their roles and responsibilities, identified in, for example, a relevant Code of Practice and non-statutory Governmental guidelines.

Sample questions from a suitable puzzle (the second) questionnaire are provided in Example B, below:

The puzzle questionnaire of Example B is deigned to test a variety of key problem-solving and decision-making skills relevant to the duties of the subject(s). These skills may be tested from a number of different aspects, including:

Information efficiency—how subject(s) search for and use available information to make decisions in particular circumstances and how application of social or relevant rules can alter the consistency of method used to solve such problems across individuals and within boards.

Sub-additivity—to test if subject(s) are aware of, and can consistently apply, the sub-additivity rule (i.e. the same of probabilities in any situation cannot be in excess of 100% of 10/10) even in the presence of large volumes of irrelevant data. To test for individual consistency across differently framed sub-additivity problems requiring the said rule to be upheld and to test for collective consistency within the board.

Probability—a test subject'(s') awareness of basic principles of probability, ability to answer a basic probability calculation and recognition of situations in which probabilities are reciprocal. To test for individual consistency across differently framed probability problems requiring the logical process and to test for collective consistency within the board.

Short-cuts—to test for subject awareness of, for example, the recognition fallacy (i.e. that in situations of limited information and knowledge, people tend to select an answer based on what most easily comes to mind).

Demographics—to test subject knowledge of relevant demographics, such as projected retirement and workforce demographics, and to test for individual consistency with regard to, for example, levels of immigration and supporting state pensions systems (where subject(s) are pensions related investors).

It will be appreciated by one or ordinary skill in the art that the questions in the puzzle (the second) questionnaire are designed to evaluate the decision-making styles and problem-solving processes of subject(s), their use of heuristics (short-cuts) and bias, and their interpretation of and solutions to differently framed (but actually identical) questions.

Data collected in the form of answers to the questions set in both questionnaires can be coded (classified), and then input into a statistical software package and, from the resulting data files, graphical representation of frequencies can be created and cross tabulation of relationships between variables can be performed. For example, the results of completion of the two questionnaires could be coded and entered into a statistical software package, such as SPSS or Windows, the functionality of which allows rapid output of graphs and diagrams to facilitate descriptive on-parametric correlation of results (both for individuals and within a collective, e.g. a histogram indicating the number of people on within a collective who were consistently correct in answering a particular type of puzzle). Parametric statistical analysis may also be facilitated by the statistical software package.

In any event, the results of completion of the questionnaires are analysed so as to form conclusions on the competency, consistency, knowledge and understanding, and governance structures of individuals and collective bodies and, based on the results of this non-parametric and parametric analysis, proposals and recommendations can be made as to how individual and collective decision-making skills can be improved.

Exemplary results of such analysis in respect of selected questions relating to the field pension fund trusteeship are illustrated in Example C, below:

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

We claim:

1. A method of determining at least one of decision-making competence, consistency, knowledge and understanding and governance structures of subject(s) in a specified field of risk, the method comprising obtaining answers to a first set of questions designed to ascertain opinions, attitudes and/or beliefs of said subject(s) within said specified field, obtaining answers to a second set of questions designed to evaluate decision-making systems and/or problem-solving processes of subject(s), and correlating said answers to said first and second sets of questions so as to determine the individual and/or collective decision-making competence of said subject(s) within said field.

2. A method according to claim 1, wherein said first set of questions comprises a continuation of questions designed to determine one or more of demographic background relating to said subject(s), attitude of raid subject to governance of said specified field, and knowledge and understanding of said subject(s) in respect of key aspects of said specified field.

3. A method according to claim 1, wherein said second set of questions comprises a combination of questions designed to test key problem-solving and/or decision-making skills of said subject(s) in respect of their duties with said specified field.

4. A method according to claim 4, wherein said skills include one or more of information efficiency, awareness of common decision-fallacies, knowledge and understanding of basic principles of probability, and demographics relating to said specified field.

5. A method according to claim 1, wherein data representative of said answers to said questions is coded (classified) and entered into a statistical analysis application arranged and configured to correlate said answers and generate a visual representative of said correlated answers for use in analysis thereof.

6. A questionnaire for use in the method of claim 1, said questionnaire including a first questionnaire comprising a set of questions designed to ascertain opinions, attitudes and/or beliefs of said subject(s) within said specified field and a second questionnaire comprising a set of questions designed to evaluate decision-making styles and problem-solving processes of said subject(s).

7. A questionnaire according to claim 6, wherein said first set of questions comprises a continuation of questions designed to determine one or more of demographic background relating to said subject(s), attitude of said subject to governance of said specified field, and knowledge and understanding of said subject(s) in respect of key aspects of said specified field.

8. A questionnaire according to claim 6, wherein said second set of questions comprises a combination of questions designed to test key problem-solving and/or decision-making skills of said subject(s) in respect of their duties with said specified field.

9. A questionnaire according to claim 8, wherein said skills include one or more information efficiency, awareness of common decision-fallacies, knowledge and understanding of basic principles of probability, and demographics relating to said specified field.

10. A database in which is stored a plurality of questions for use in a method according to claim 1, the question including at least at set of questions designed to ascertain opinions, attitudes and/or beliefs of said subject(s) within said specified field and a second questionnaire comprising a set of questions designed to evaluate decision-making styles and/or problem-solving processes of said subject(s).

11. A database according to claim 10, wherein said first set of questions comprises a continuation of questions designed to determine one or more of demographic background relating to said subject(s), attitude of raid subject to governance of said specified field, and knowledge and understanding of said subject(s) in respect of key aspects of said specified field.

12. A database according to claim 10, wherein said second set of questions comprises a combination of questions designed to test key problem-solving and/or decision-making skills of said subject(s) in respect of their duties with said specified field.

13. A database according to claim 12, wherein said skills include one or more of information efficiency, awareness of common decision-fallacies, knowledge and understanding of basic principles of probability, and demographics relating to said specified field.

14. A system for determining one or more of the individual and/or collective decision-making competence, consistency, knowledge and understanding, and governance structures of subject(s) in a specified field of risk, the system comprising an input for receiving a subject's answers to the sets of questions provided in the first and second respective questionnaires as defined above, an analysis tool for correlating data representative of said answers and generating visual and/or graphic representations of said answers, and a display for displaying said representations so as to enable a user to determine therefrom one or more of the decision-making competence, consistency, knowledge and understanding, and governance structures of said subject(s) within said field.

15. A system according to claim 14, wherein said first set of questions comprises a continuation of questions designed to determine one or more of demographic background relating to said subject(s), attitude of raid subject to governance of said specified field, and knowledge and understanding of said subject(s) in respect of key aspects of said specified field.

16. A system according to claim 14, wherein said second set of questions comprises a combination of questions designed to test key problem-solving and/or decision-making skills of said subject(s) in respect of their duties with said specified field.

17. A system according to claim 16, wherein said skills include one or more of information efficiency, awareness of common decision-fallacies, knowledge and understanding of basic principles of probability, and demographics relating to said specified field.

18. A system according to claim 14, wherein data representative of said answer to said questions is coded and entered into a statistical analysis application arranged and configured to correlate said answers and generate a visual representative of said correlated answers for use in analysis thereof.
